(19) United States
(12) Patent Application Publication
(10) Pub. No.: US 2025/0073744 A1
(43) Pub. Date: Mar. 6, 2025

(54) EJACULATE DISPENSING DEVICE AND METHOD OF MAKING THE SAME

(71) Applicant: Marcus Burke, Orlando, FL (US)

(72) Inventor: Marcus Burke, Orlando, FL (US)

(21) Appl. No.: 18/458,560

(22) Filed: Aug. 30, 2023

(51) Int. Cl. B05C 17/005; B05B 11/00

(52) U.S. Cl. CPC B05C 17/00569; B05B 11/0089

(57) ABSTRACT

Various implementations include an ejaculate dispensing device. The device includes an elongated male member, a reservoir, a pump, and a trigger. The elongated male member has a distal end and a proximate end. The elongated male member defines a longitudinally extending channel having a first end and a second end. The longitudinally extending channel extends from the first end at the distal end toward the second end at the proximate end. The reservoir is for containing a fluid. The pump has an inlet and an outlet. The outlet is in fluid communication with the first end of the longitudinally extending channel, and the inlet is in fluid communication with the reservoir. The trigger is for actuating the pump to cause a fluid to flow from the reservoir, through the longitudinally extending channel, and out of the distal end of the elongated male member.

### FIELD

This disclosure relates to the field of sexual devices. More particularly, this disclosure relates to an ejaculate dispensing device that simulates ejaculation.

### BACKGROUND

Various sexual devices exist that provide sexual stimulation and may replicate the act of male ejaculation. For example, U.S. Pat. No. 6,350,230 describes a sexual aid device that includes elements to dispense a fluid and thereby simulate ejaculation. Similarly, U.S. Pat. No. 7,163,508 describes a lubricating sexual aid that also emits a fluid from the device to simulate ejaculate.

While these and other devices provide an artificial means of ejaculation, often the simulated act is unrealistic and creates an unrealistic appearance of the act of ejaculating. Further, these devices are unrealistic in appearance and may not be suitable for use in the production of adult entertainment.

What is needed, therefore, is an ejaculate dispensing device that creates a realistic simulation of the act of ejaculating.

### SUMMARY

The above and other needs are met by an ejaculate dispensing device. In a first aspect, an ejaculate dispensing device includes: a pump head including a pump trigger hingedly associated with the pump head, the pump head comprising a threaded lower end and an outlet end; a dip tube located on the lower end of the pump head, the dip tube terminating at a distal end extending from the lower end of the pump head; an adapter coupled to the outlet end of the pump head, the adapter reducing a diameter of the outlet end to an adapter outlet end; an elongate section of flexible tubing coupled to the adapter outlet end, the elongate section of flexible tubing comprising a first end proximate to the adapter outlet end and a second end distal from the first end; and a nozzle inserted into the second end of the elongate section of flexible tubing.

In one embodiment, the ejaculate dispensing device further includes a reservoir bottle having a threadable upper end shaped to engage the threaded lower end of the pump head. In another embodiment, the reservoir bottle has a volume of less than six ounces.

In yet another embodiment, the elongate section of flexible tubing is translucent. In one embodiment, the adapter is shaped to fit over the outlet end of the pump head.

In another embodiment, the adapter further comprising an adapter outlet shaped to have a press fit engagement with the elongate section of flexible tubing.

In a second aspect, a method of making an ejaculate dispensing device includes: providing a pump head having a threaded lower end, a pump handle hingedly associated with the pump head, an elongate dip tube extending from the pump head, and sprayer nozzle located on an outlet end of the pump head; trimming the elongate dip tube to a length such that the elongate dip tube terminates adjacent a bottom end of the pump head; coupling an adapter to the end of the sprayer nozzle, the adapter reducing a diameter of the end of the sprayer nozzle to an outlet end sized to receive a piece of elongate flexible tubing; coupling a section of elongate flexible tubing to the outlet end of the adapter, the elongate flexible tubing extending from a proximate end adjacent the adapter to a distal end; coupling a nozzle to the distal end of the elongate flexible tubing; and providing a reservoir bottle including a threaded upper end shaped to engage the threaded lower end of the pump head, the reservoir bottle having a volume of less than six ounces.

Various other implementations include an ejaculate dispensing device. The device includes an elongated male member, a reservoir, a pump, and a trigger. The elongated male member has a distal end and a proximate end opposite and spaced apart from the distal end. The elongated male member defines a longitudinally extending channel having a first end and a second end opposite and spaced apart from the first end. The longitudinally extending channel extends from the first end at the distal end toward the second end at the proximate end. The reservoir is for containing a fluid. The pump has an inlet and an outlet. The outlet is in fluid communication with the first end of the longitudinally extending channel, and the inlet is in fluid communication with the reservoir. The trigger is for actuating the pump to cause a fluid to flow from the reservoir, through the longitudinally extending channel, and out of the distal end of the elongated male member.

In some implementations, the elongated male member has a phallic shape. In some implementations, the elongated male member includes a testicle portion shaped to resemble testicles.

In some implementations, the elongated male member comprises a polymer. In some implementations, the polymer is a resilient polymer.

In some implementations, the longitudinally extending channel extends from the distal end to the proximate end. In some implementations, the elongated member has a side wall extending from the distal end to the proximate end. In some implementations, the longitudinally extending channel extends from the distal end to the side wall.

In some implementations, the device further includes a pump head including a pump trigger hingedly associated with the pump head. In some implementations, the pump head includes a threaded lower end and an outlet end.

In some implementations, the device further includes a dip tube coupled to the outlet of the pump. In some implementations, the inlet of the pump is in fluid communication with the reservoir through the dip tube.

In some implementations, the elongated male member is removably coupled to the outlet of the pump.

In some implementations, the device further includes a flexible tubing extending through the longitudinally extending channel of the elongated male member. In some implementations, the outlet of the pump is in fluid communication with the flexible tubing. In some implementations, the elongated male member and the flexible tubing comprise different materials.

In some implementations, the device further includes a nozzle in fluid communication with the first end of the longitudinally extending channel and disposed adjacent the distal end of the elongated male member. In some implementations, the device further includes a flexible tubing extending through the longitudinally extending channel of the elongated male member. In some implementations, the nozzle is coupled to the flexible tubing.

In some implementations, the reservoir includes a bottle having a threadable upper end shaped to engage a threaded lower end of the pump. In some implementations, the bottle has a volume of less than six ounces.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows an ejaculate dispensing device according to one embodiment of the present disclosure;

FIG. 2 shows a pump head and adapter of an ejaculate dispensing device according to one embodiment of the present disclosure;

FIG. 3 shows a pump head and elongate tubing of an ejaculate dispensing device according to one embodiment of the present disclosure;

FIG. 4 shows a close up view of an adaptor according to one embodiment of the present disclosure; and

FIG. 5 shows a close up view of a flexible tubing nozzle according to one embodiment of the present disclosure.

FIG. 6 shows a perspective view of an ejaculate dispensing device according to another implementation.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

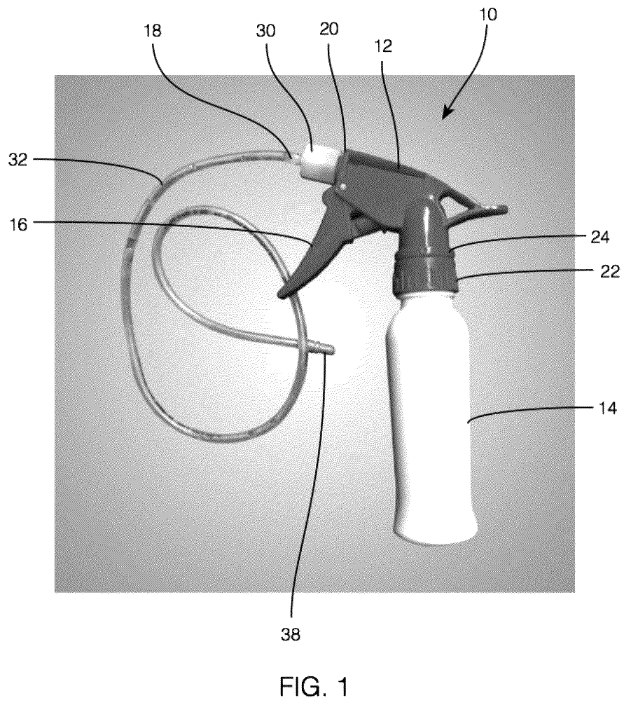

FIG. 1 shows a basic embodiment of an ejaculate dispensing device 10 for realistically dispensing an ejaculate fluid from the ejaculate dispensing device 10. The ejaculate dispensing device 10 advantageously dispenses an ejaculate material from the dispensing device 10 with sufficient velocity such that operation of the ejaculate dispensing device 10 creates a realistic appearance of an act of ejaculating.

As referred to herein, a suitable ejaculate material is preferably an artificial substance having a viscosity and consistency similar to that of natural ejaculate. Various known artificial ejaculate materials may be suitable for use with the ejaculate dispensing device 10.

With further reference to FIG. 1, the ejaculate dispensing device 10 includes a pump head 12 and an ejaculate reservoir 14 removably attached to the pump head 12. The pump head 12 includes a pump trigger 16 hingedly attached to the pump head 12. The pump trigger 16 is mechanically coupled with the pump head 12 such that operation of the pump trigger 16 operates pumping of the pump head 12. Internal components of the pump head 12 may be formed according to known pumping devices, such as a piston and spring configuration wherein the piston is mechanically associated with the pump trigger 16. The pump head 12 includes an outlet end 18 located at a front 20 of the pump head 12. The pump head 12 further includes a threaded lower end 22 located on a bottom 24 of the pump head.

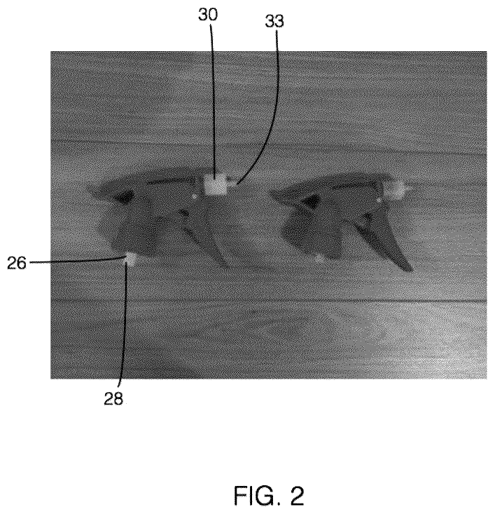

Referring to FIG. 2, a dip tube 26 is coupled to the pump head 12 and in fluid communication with the outlet end 18 through the pump head 12. The dip tube 26 extends from a proximal end adjacent the threaded lower end 22 of the pump head to a distal end 28 that extends into the ejaculate reservoir 14. The dip tube 26 preferably has a length such that the distal end 28 of the dip tube 26 terminates adjacent at a point that is proximal to the bottom 24 of the pump head 12 such that the dip tube 26 does not extend towards a bottom of the ejaculate reservoir. The dip tube 26 is preferably formed of a resiliently flexible tubing such that the dip tube 26 maintains a shape of the dip tube 26 when the dip tube is located within the ejaculate reservoir 14 and a ejaculate material is also in the ejaculate reservoir 14.

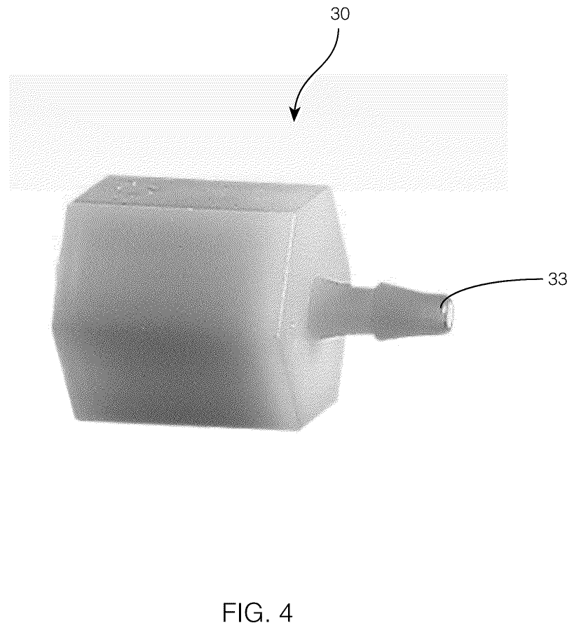

An adapter 30 (FIG. 4) is attached to the outlet end 18 of the pump head 12. The adapter 30 preferably reduces a diameter of the outlet end 18 of the pump head 12 such that an elongate section of tubing 32 may be coupled with the pump head 12 through the adapter 30. The adapter 30 preferably fits over the outlet end 18 of the pump head 12, and is preferably held in place such as with an adhesive or by threaded engagement of the adapter 30 to the pump head 12. The adapter 30 includes an adapter outlet 33 formed on a distal end of the adapter, the adapter outlet 32 having a diameter such that the elongate section of tubing 32 may be press fit over the adapter outlet 32. The adapter outlet 33 is preferably barbed or similarly shaped to retain the elongate section of tubing 32 on the adapter outlet 33.

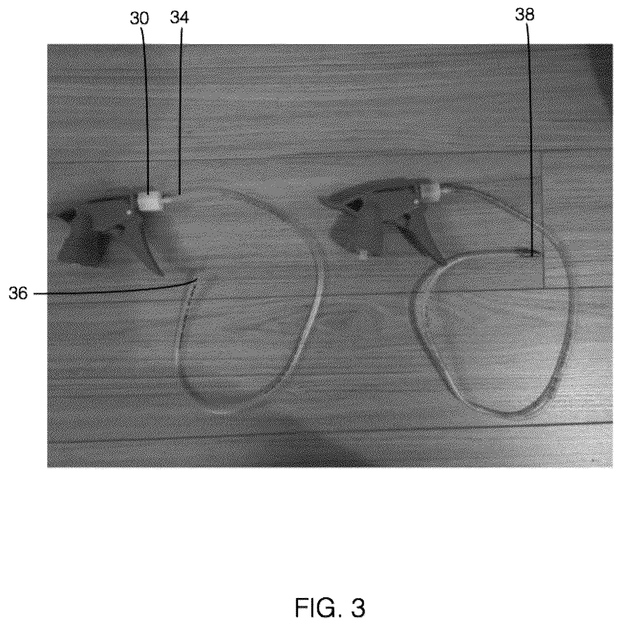

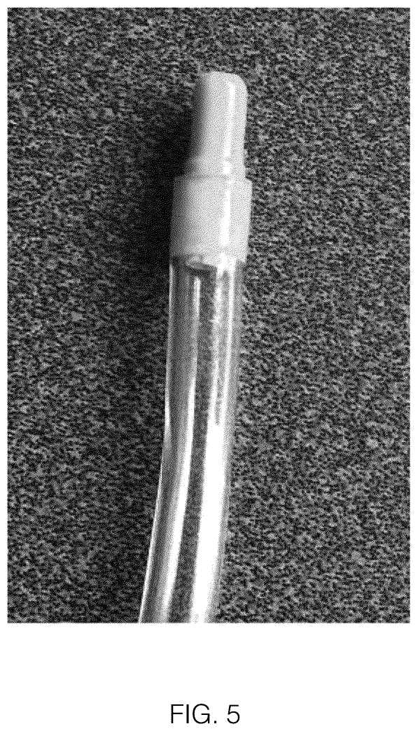

Referring to FIG. 3, the elongate section of tubing 32 is preferably formed of a flexible material, and is preferably formed of medical tubing or other like materials. Suitable materials include hypoallergenic tubing that does not kink when manipulated or to adhere to bare skin. The elongate section of tubing 32 extends from a first end 34 adjacent to the outlet end 18 of the pump head 12 to a distal end 36 that is distal from the pump head 12. The elongate section of tubing 32 is preferably elongate in length, and preferably has a length greater than approximately three inches. A flexible tubing nozzle 38 (FIG. 5) is located at the distal end 36 of the elongate section of tubing 32, and includes an outlet having a reduced size relative to the elongate section of tubing 32. The flexible tubing nozzle 38 is preferably a highly visible color, such as a bright green, such that the flexible tubing nozzle 38 is visible if it appears within a camera shot of a production.

Referring again to FIG. 1, the ejaculate reservoir 14 is preferably shaped to threadably engage with the lower end 22 of the pump head 12. The ejaculate reservoir 14 is preferably undersized relative to a size of the pump head 12, and preferably has a volume of six ounces or less. The ejaculate reservoir 14 is preferably formed of a polymer and may include transparent walls such that contents of the ejaculate reservoir 14 are viewable.

In operation, an ejaculate material is placed within the ejaculate reservoir 14. To operate the ejaculate dispensing device 10, a user inverts the ejaculate dispensing device 10 such that the ejaculate material flows into the dip tube 26. The user manipulates the pump trigger 16 to initially draw ejaculate material into the dip tube 26, into the pump head 12, and through the elongate section of flexible tubing 32. When the ejaculate material is initially primed into the pump head 12 and elongate section of flexible tubing 32, the user may subsequently manipulate the pump trigger 16 to eject ejaculate material from the flexible tubing nozzle 38.

A user may hold the dispensing device 10 in one of the user's hand and conceal the device behind the user. The elongate flexible tubing 32 allows the flexible tubing nozzle 38 to be located distally from the pump head 12, and the flexible tubing 32 may be routed along a user's body to a desired location while remaining out of a line of sight of a camera used in a production.

It has been found that the unique combination of elements in the ejaculate dispensing device 10 creates dispenses the ejaculate material in a realistic manner and allows the pump head 12 to pump and dispense the relatively viscous ejaculate material. Further, providing a reservoir chamber having a relatively small size, such as a preferable size of 8 ounces or less, has been found to enhance operation of the device 10. The ejaculate dispensing device 10 of the present disclosure advantageously allows a user to dispense an ejaculate material with a velocity sufficient to create the appearance of natural act of ejaculating. The ejaculate dispensing device 10 is readily refillable and easily cleaned. The ejaculate dispensing device 10 is particularly well suited for adult film production sets, where the ejaculate dispensing device 10 may recreate a natural appearing act of ejaculation without requiring a performer to perform the act.

Various other implementations include an ejaculate dispensing device. The device includes an elongated male member, a reservoir, a pump, and a trigger. The elongated male member has a distal end and a proximate end opposite and spaced apart from the distal end. The elongated male member defines a longitudinally extending channel having a first end and a second end opposite and spaced apart from the first end. The longitudinally extending channel extends from the first end at the distal end toward the second end at the proximate end. The reservoir is for containing a fluid. The pump has an inlet and an outlet. The outlet is in fluid communication with the first end of the longitudinally extending channel, and the inlet is in fluid communication with the reservoir. The trigger is for actuating the pump to cause a fluid to flow from the reservoir, through the longitudinally extending channel, and out of the distal end of the elongated male member.

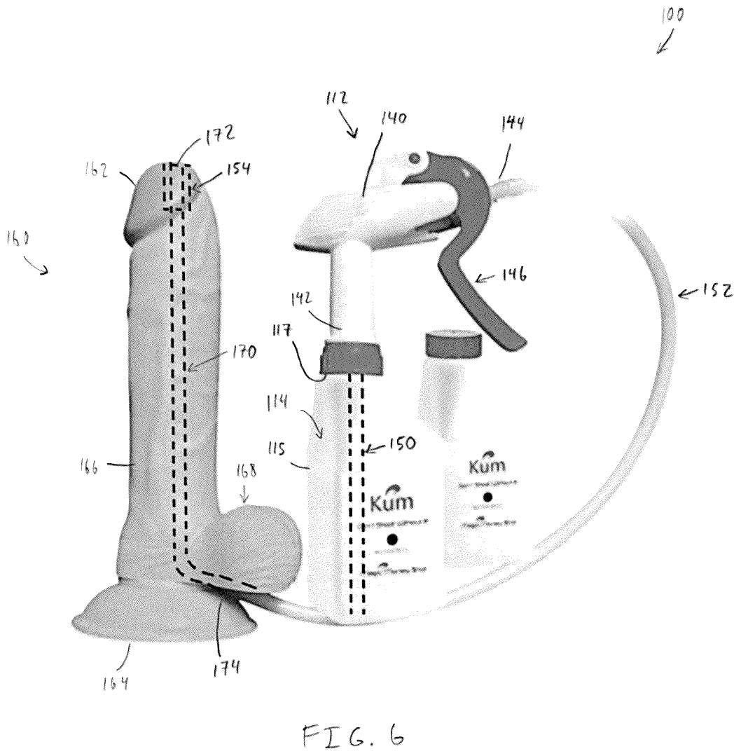

FIG. 6 shows an ejaculate dispensing device 100 according to one implementation. The device 100 includes an elongated male member 160, a reservoir 114, a pump 140, and a trigger 116. FIG. 6 includes similar features to those shown in FIGS. 1-5, and it is understood that any features that are possible with the implementations shown in FIGS. 1-5 could also be included in the implementations shown in FIG. 6.

The elongated male member 160 has a distal end 162, a proximate end 164 opposite and spaced apart from the distal end 162, and a side wall 166 extending from the distal end 162 to the proximate end 164. The elongated male member 160 shown in FIG. 6 has a phallic shape to resemble human male genitalia and further includes a testicle portion 168 that is shaped to resemble human testicles. However, in some implementations, the elongated male member does not include a testicle portion. Also, in other implementations, the elongated male member can be any desired length, diameter, and/or shape.

The elongated male member 160 shown in FIG. 6 is made of a resilient polymer, but in other implementations, the elongated male member can be made out of any desired material.

The elongated male member 160 defines a longitudinally extending channel 170 having a first end 172 and a second end 174 opposite and spaced apart from the first end 172. The longitudinally extending channel 170 extends from its first end 172 at the distal end 162 of the elongated mail member 160 toward the second end 174 of the longitudinally extending channel 170 at the proximate end 164 of the elongated mail member 160. The longitudinally extending channel 170 shown in FIG. 6 extends from the distal end 162 of the elongated male member 160 to a portion of the sidewall 166 adjacent the proximate end 164 of the elongated male member 160 behind the testicle portion 168. However, in some implementations, the longitudinally extending channel extends from the distal end of the elongated male member to the proximate end of the elongated male member. In some implementations, the longitudinally extending channel extends from the distal end of the elongated male member to any portion of the sidewall of the elongated male member.

The reservoir 114 is configured to contain a fluid and is defined by a container 115 or bottle having an opening 117. A portion of the container 115 adjacent the opening 117 defines a threaded upper end portion configured to engage a threaded lower end portion of the pump head 112 for coupling the pump head 112 to the container 115, as discussed below.

The container 115 defining the reservoir 114 shown in FIG. 6 has a volume of 6 ounces or less. However, in some implementations, the container has any desired volume for containing any desired amount of fluid. For example, in some implementations, the volume of the reservoir 114 is 4 ounces.

The pump 140 has an inlet 142 and an outlet 144 and is contained within the pump head 112. The pump 140 is configured to create a pressure differential across the inlet 142 and the outlet 144 to cause fluid to flow from the inlet 142 toward the outlet 144. The pump head 112 includes a trigger 146 hingedly associated with the pump head 112 for actuating the pump 140 to cause fluid to flow from the reservoir 114 through the longitudinally extending channel 170 and out of the distal end 162 of the elongated male member 160, as discussed below. The pump 140 shown in FIG. 6 is configured to distribute 1 mL of fluid per actuation by trigger pull, but in other implementations, the pump can be configured to output any desired amount of fluid or can be adjustable to a desired volume of output per actuation.

A dip tube 150 is coupled to, and in fluid communication with, the inlet 142 of the pump 140. The dip tube 150 is configured such that, when the pump head 112 is coupled to the container 115, the dip tube 150 is extendable into the container 115 such that the inlet 142 of the pump 140 is in fluid communication with the reservoir 114 through the dip tube 150.

A flexible tubing 152 is coupled to, and in fluid communication with, the outlet 144 of the pump 140. The flexible tubing 152 extends through the longitudinally extending channel 170 of the elongated male member 160. The flexible tubing 152 is configured such that the outlet 144 of the pump 140 is in fluid communication with the first end 172 of the longitudinally extending channel 170 and the distal end 162 of the elongated male member 160.

A nozzle 154 is coupled to the end of the flexible tubing 152 adjacent the distal end 162 of the elongated male member 160 and is in fluid communication with the first end 172 of the longitudinally extending channel 170. The nozzle 154 is configured to provide a desired shape and opening area for a desired dispensing of the fluid. In some implementations, the nozzle is adjustable (e.g., by twisting a first portion of the nozzle relative to a second portion of the nozzle) to increase or decrease the effective opening size or to change the shape of the opening.

The flexible tubing 152 shown in FIG. 6 is removably disposed within the longitudinally extending channel 170 of the elongated male member 160 such that the elongated male member 160 can be decoupled from the rest of the device 100 and replaced with a different elongated male member 160. However, in some implementations, the elongated male member is permanently coupled to the rest of the device. In some implementations, the device does not include a flexible tubing, and the outlet is coupled directly to the second end of longitudinally extending channel. In some implementations, the flexible tubing only extends to the second end of longitudinally extending channel to place the outlet of the pump in fluid communication with the first end of the longitudinally extending channel. In implementations in which the flexible tubing does not extend to the first end of the longitudinally extending channel, the nozzle can be coupled to the first end of longitudinally extending channel such that fluid from pump flows through the longitudinally extending channel to the nozzle. In some implementations, the device does not include a nozzle. In some implementations, the elongated male member acts as the nozzle or includes a built-in nozzle. The elongated male member and the flexible tubing shown in FIG. 6 are made of different materials, but in some implementations, the elongated male member and the flexible tubing can be made of the same material.

In use, the reservoir 114 of the container 115 is filled with a fluid. The threaded lower end portion of the pump head 112 is threadingly coupled to the threaded upper end portion of the opening 117 of the container 115 such that the dip tube 150 extends into the reservoir 114 and into the fluid.

The flexible tubing 152 is inserted into the second end 174 of the longitudinally extending channel 170 defined by the elongated male member 160 and advanced to the first end 172 of the longitudinally extending channel 170 at the distal end 162 of the elongated male member 160. If the nozzle 154 is adjustable, then the nozzle 154 can be adjusted to the desired setting.

The hinged trigger 116 is then depressed to actuate the pump 140 of the pump head 112. The actuation of the pump 140 causes a pressure differential between the inlet 142 and the outlet 144 of the pump 140. This pressure differential causes fluid in the reservoir 114 to flow from the reservoir 114, into the dip tube 150, through the pump 140, through the flexible tubing 152, and out of the first end 172 of the longitudinally extending channel 170 of the elongated male member 160. The pressure from the pump 140 is enough to cause the fluid to exit the longitudinally extending channel 170 with enough velocity to separate from the elongated male member 160.

The device 100 shown in FIG. 6 provides certain advantages over the prior art. For example, the trigger design of the device 100 is a much more efficient way to deliver the output over the syringe or squeeze ball methods still currently used. The device provides a “plug-and-play” type device for quickly distributing a fluid. The prior art methods require the fluid to be first drawn up into the syringe or squeeze ball in a messy and time consuming process which also requires a bowl as well as the fluid. For the device 100 shown in FIG. 6, the trigger style pump simply screws into the container leaving zero mess and is ready to go in seconds.

Furthermore, the trigger mechanism 116 of the present device 100 provides considerably more power and distance than a syringe or squeeze ball. The trigger 116 also provides more control than a syringe or squeeze ball, allowing more realistic combinations of short and long squirts simply by control of the trigger 116. This would be very difficult to do with a syringe, for example. The prior art methods offer almost no control over output or distance.

Also, the container 115 provides a larger fluid reservoir 114 than a syringe or squeeze ball, allowing for longer use time between refilling the device.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. An ejaculate dispensing device comprising:
an elongated male member having a distal end and a proximate end opposite and spaced apart from the distal end, the elongated male member defining a longitudinally extending channel having a first end and a second end opposite and spaced apart from the first end, wherein the longitudinally extending channel extends from the first end at the distal end toward the second end at the proximate end;
a reservoir for containing a fluid;
a pump having an inlet and an outlet, wherein the outlet is in fluid communication with the first end of the longitudinally extending channel and the inlet is in fluid communication with the reservoir; and
a trigger for actuating the pump to cause a fluid to flow from the reservoir through the longitudinally extending channel and out of the distal end of the elongated male member.

2. The ejaculate dispensing device of claim 1, wherein the elongated male member has a phallic shape.

3. The ejaculate dispensing device of claim 1, wherein the elongated male member includes a testicle portion shaped to resemble testicles.

4. The ejaculate dispensing device of claim 1, wherein the elongated male member comprises a polymer.

5. The ejaculate dispensing device of claim 4, wherein the polymer is a resilient polymer.

6. The ejaculate dispensing device of claim 1, wherein the longitudinally extending channel extends from the distal end to the proximate end.

7. The ejaculate dispensing device of claim 1, wherein the elongated member has a side wall extending from the distal end to the proximate end, wherein the longitudinally extending channel extends from the distal end to the side wall.

8. The ejaculate dispensing device of claim 1, further comprising a pump head including a pump trigger hingedly associated with the pump head, the pump head comprising a threaded lower end and an outlet end.

9. The ejaculate dispensing device of claim 1, further comprising a dip tube coupled to the outlet of the pump, wherein the inlet of the pump is in fluid communication with the reservoir through the dip tube.

10. The ejaculate dispensing device of claim 1, wherein the elongated male member is removably coupled to the outlet of the pump.

11. The ejaculate dispensing device of claim 1, further comprising a flexible tubing extending through the longitudinally extending channel of the elongated male member, wherein the outlet of the pump is in fluid communication with the flexible tubing.

12. The ejaculate dispensing device of claim 11, wherein the elongated male member and the flexible tubing comprise different materials.

13. The ejaculate dispensing device of claim 1, further comprising a nozzle in fluid communication with the first end of the longitudinally extending channel and disposed adjacent the distal end of the elongated male member.

14. The ejaculate dispensing device of claim 13, further comprising a flexible tubing extending through the longitudinally extending channel of the elongated male member, wherein the nozzle is coupled to the flexible tubing.

15. The ejaculate dispensing device of claim 1, wherein the reservoir comprises a bottle having a threadable upper end shaped to engage a threaded lower end of the pump.

16. The ejaculate dispensing device of claim 15, wherein the bottle has a volume of less than six ounces.
